(19) United States
(12) Patent Application Publication
(10) Pub. No.: US 2015/0310856 A1
(43) Pub. Date: Oct. 29, 2015

(54) SPEECH RECOGNITION APPARATUS, SPEECH RECOGNITION METHOD, AND TELEVISION SET

(71) Applicant: Panasonic Intellectual Property Management Co., Ltd., Osaka (JP)

(72) Inventor: Tomohiro KOGANEI, Osaka (JP)

(21) Appl. No.: 14/795,097

(22) Filed: Jul. 9, 2015

Related U.S. Application Data
(62) Division of application No. 14/037,451, filed on Sep. 26, 2013.

(30) Foreign Application Priority Data
Dec. 25, 2012 (JP) 2012-281461

(51) Int. Cl. G10L 15/08; G06F 3/14; G10L 17/22

(52) U.S. Cl. CPC G10L 15/08; G10L 17/22; G06F 3/1407

(57) ABSTRACT

A speech recognition apparatus includes: a speech acquisition unit which acquires speech uttered by a user; a recognition result acquisition unit which acquires a result of recognition performed on the acquired speech; an extraction unit which, when the recognition result includes a keyword and a selection command that is used for selecting one of selectable information items, extracts a selection candidate that includes the keyword; a selection mode switching unit which, when more than one selection candidate is extracted, switches a selection mode from a first selection mode that allows selection among the selectable information items to a second selection that allows selection among the selection candidates; a display control unit which changes a display manner of the display information, according to the second selection mode switched from the first selection mode; and a selection unit which selects one of the selection candidates, according to an entry from the user.

### CROSS REFERENCE TO RELATED APPLICATION

The present application is based on and claims priority of Japanese Patent Application No. 2012-281461 filed on Dec. 25, 2012. The entire disclosure of the above-identified application, including the specification, drawings and claims is incorporated herein by reference in its entirety.

### FIELD

One or more exemplary embodiments disclosed herein relate generally to speech recognition apparatuses, speech recognition methods, and television sets for recognizing speech of a user to allow the user to select one of information items.

### BACKGROUND

As an example, a conventional speech input apparatus receives an input of speech uttered by a user, analyzes the received speech input to recognize a command, and controls a device according to the recognized command (see Patent Literature 1, for example). To be more specific, the speech input apparatus disclosed in Patent Literature 1 recognizes the speech uttered by the user and then controls the device according to the command obtained as a result of the recognition.

Here, while operating a browser using, for example, a television set or a personal computer (PC), the user has a need for speech recognition to be performed by such a speech input apparatus to select a hypertext displayed on a screen of the browser. To be more specific, the user has a need for selecting the hypertext through speech recognition. Here, the hypertext refers to information for, when selected, accessing related information referenced by a hyperlink (reference information) embedded in the present hypertext. Hereafter, the information such as the hypertext is referred to as the “selectable information item”.

### CITATION LIST

### Patent Literature

Japanese Patent No. 4812941

### SUMMARY

However, when the selectable information item is selected through speech recognition, a selectable information item that the user does not intend to select may be selected by mistake.

In view of this, one non-limiting and exemplary embodiment provides a speech recognition apparatus and so forth capable of easily selecting, through speech recognition, a selectable information item that a user intends to select out of selectable information items.

In one general aspect, the techniques disclosed here feature a speech recognition apparatus which assists a user to select one of selectable information items when display information including the selectable information items is being outputted, the speech recognition apparatus including: a speech acquisition unit which acquires speech uttered by the user; a recognition result acquisition unit which acquires a result of recognition performed on the speech acquired by the speech acquisition unit; an extraction unit which, when the recognition result includes a keyword and a selection command that is used for selecting one of the selectable information items, extracts at least one selection candidate that includes the keyword, from the selectable information items; a selection mode switching unit which switches a selection mode from a first selection mode to a second selection mode when the at least one selection candidate extracted by the extraction unit comprises a plurality of selection candidates, the selection mode causing one of the selectable information items to be selected, the first selection mode allowing a selection to be made from among the selectable information items, and the second selection mode allowing the selection to be made from among the selection candidates; a display control unit which changes a display manner in which the display information is displayed, according to the second selection mode switched from the first selection mode by the selection mode switching unit; and a selection unit which selects one of the selection candidates, according to an entry made by the user after the display control unit changes the display manner in which the display information is displayed.

One or more exemplary embodiments or features disclosed herein provide a speech recognition apparatus capable of easily selecting, through speech recognition, a selectable information item that a user intends to select.

### BRIEF DESCRIPTION OF DRAWINGS

These and other advantages and features will become apparent from the following description thereof taken in conjunction with the accompanying Drawings, by way of non-limiting examples of embodiments of the present disclosure. In the Drawings:

FIG. 1 is a diagram showing a speech recognition system in Embodiment.

FIG. 2 is a block diagram showing a configuration of the speech recognition system.

FIG. 3 is a diagram explaining dictation.

FIG. 4 is a flowchart showing a flow of selection processing performed by a speech recognition apparatus in Embodiment.

FIG. 5A is a diagram showing an image of Internet search results.

FIG. 5B is a diagram showing an example where a selection mode in selection processing is set to a second selection mode.

FIG. 5C is a diagram explaining the second selection mode.

FIG. 6 is a diagram showing search results obtained using an electronic program guide (EPG).

FIG. 7 is a diagram showing an example where the search results obtained by the EPG is drawn as a list.

FIG. 8 is a diagram explaining about the case where a search command type is not specified.

FIG. 9A is a diagram showing an example where a selection mode is a second selection mode in selection processing in another embodiment.

FIG. 9B is a diagram explaining the second selection mode in the other embodiment.

### DETAILED DESCRIPTION OF INVENTION

Hereinafter, certain exemplary embodiments are described in greater detail, with reference to the accompanying Drawings as necessary. However, a detailed description that is more than necessary may be omitted. For example, a detailed description on a well-known matter may be omitted, and an explanation on structural elements having the substantially same configuration may not be repeated. With this, unnecessary redundancy can be avoided in the following description, which makes it easier for those skilled in the art to understand.

It should be noted that the inventor provides the accompanying Drawings and the following description in order for those skilled in the art to fully understand the present disclosure. Thus, the accompanying Drawings and the following description are not intended to limit the subject matter disclosed in the scope of Claims.

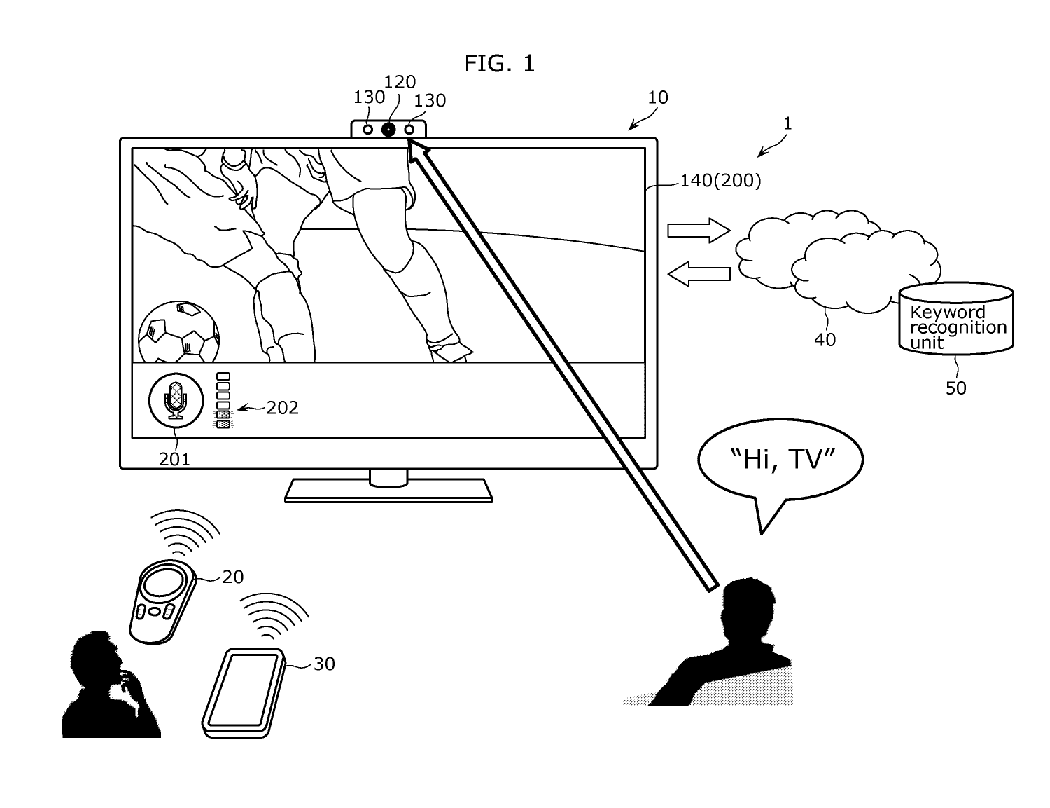

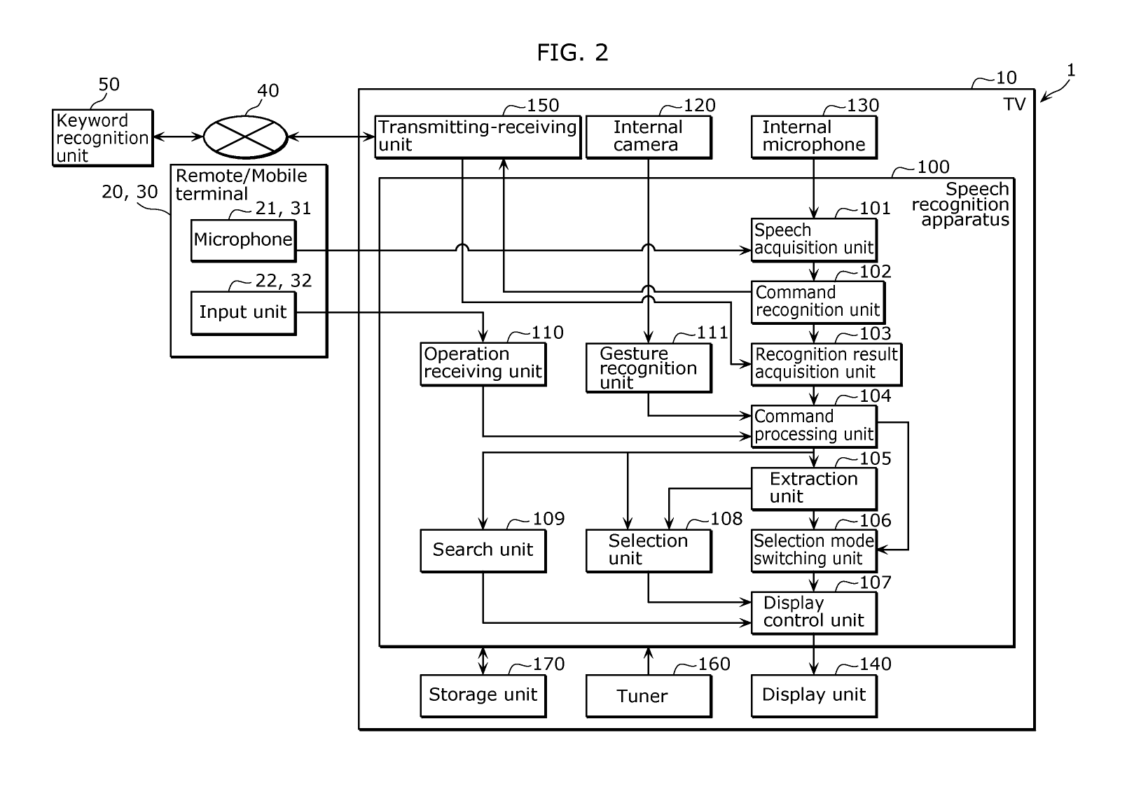

The speech recognition apparatus in the present disclosure is built in a television set (referred to as the TV) 10 as shown in FIG. 1. The speech recognition apparatus recognizes speech uttered by a user and controls the TV 10 according to a result of the speech recognition. FIG. 1 is a diagram showing a speech recognition system in Embodiment. FIG. 2 is a block diagram showing a configuration of the speech recognition system.

### Speech Recognition System

As shown in FIG. 1 and FIG. 2, a speech recognition system 1 in Embodiment includes the TV 10, a remote control (indicated as the “Remote” in FIG. 2) 20, a mobile terminal 30, a network 40, and a keyword recognition unit 50.

The TV 10 includes a speech recognition apparatus 100, an internal camera 120, an internal microphone 130, a display unit 140, a transmitting-receiving unit 150, a tuner 160, and a storage unit 170.

The speech recognition apparatus 100 acquires speech uttered by the user, analyzes the acquired speech to recognize a keyword and a command, and controls the TV 10 according to the result of the recognition. The specific configuration is described later.

The internal camera 120 is installed outside the TV 10 and shoots in the display direction of the display unit 140. To be more specific, the internal camera 120 faces in the direction in which the user is present who is facing the display unit 140 of the TV 10, and is capable of shooting the user.

The internal microphone 130 is installed outside the TV 10 and mainly collects speech heard from the display direction of the display unit 140. This display direction is the same as the direction in which the internal camera 120 shoots as described above. To be more specific, the internal microphone 130 faces in the direction in which the user is present who is facing the display unit 140 of the TV 10, and is capable of collecting speech uttered by the user.

The remote control 20 is used by the user to operate the TV 10 from a remote position, and includes a microphone 21 and an input unit 22. The microphone 21 is capable of collecting speech uttered by the user. The input unit 22 is an input device, such as a touch pad, a keyboard, or buttons, used by the user to enter an input. A speech signal indicating the speech collected by the microphone 21 or an input signal entered using the input unit 22 is transmitted to the TV 10 via wireless communication.

The display unit 140 is a display device configured with a liquid crystal display, a plasma display, an organic electrolurninescent (EL) display, or the like, and displays an image as display information generated by the display control unit 107. The display unit 140 also displays a broadcast image relating to a broadcast received by the tuner 160.

The transmitting-receiving unit 150 is connected to the network 40, and transmits and receives information via the network 40.

The tuner 160 receives a broadcast.

The storage unit 170 is a nonvolatile or volatile memory or a hard disk, and stores, for example, information for controlling the units included in the TV 10. The storage unit 170 stores, for instance, speech-command information referenced by a command recognition unit 102 described later.

The mobile terminal 30 is, for example, a smart phone in which an application for operating the TV 10 is activated. The mobile terminal 30 includes a microphone 31 and an input unit 32. The microphone 31 is built in the mobile terminal 30, and is capable of collect the speech uttered by the user as is the case with the microphone 21 of the remote control 20. The input unit 32 is an input device, such as a touch panel, a keyboard, or buttons, used by the user to enter an input. As is the case with the remote control 20, a speech signal indicating the speech collected by the microphone 31 or an input signal entered using the input unit 32 is transmitted to the TV 10 via wireless communication.

It should be noted that the TV 10 is connected to the remote control 20 or the mobile terminal 30 via wireless communication, such as a wireless local area network (wireless LAN) or Bluetooth (registered trademark). Note also that data on the speech or the like acquired from the remote control 20 or the mobile terminal 30 is transmitted to the TV 10 via this wireless communication.

The network 40 is connected by what is called the Internet.

The keyword recognition unit 50 is a dictionary server on a cloud connected to the TV 10 via the network 40. More specifically, the keyword recognition unit 50 receives speech information transmitted from the TV 10 and converts speech indicated by the received speech information into a character string (including at least one character). Then, the keyword recognition unit 50 transmits, as a speech recognition result, character information representing the speech obtained by the conversion into the character string, to the TV 10 via the network 40.

### Speech Recognition Apparatus

The speech recognition apparatus 100 includes a speech acquisition unit 101, the command recognition unit 102, a recognition result acquisition unit 103, a command processing unit 104, an extraction unit 105, a selection mode switching unit 106, a display control unit 107, a selection unit 108, a search unit 109, an operation receiving unit 110, and a gesture recognition unit 111.

The speech acquisition unit 101 acquires speech uttered by the user. The speech acquisition unit 101 may acquire the speech of the user by directly using the internal microphone 130 built in the TV 10, or may acquire the speech of the user that is acquired by the microphone 21 built in the remote control 20 or by the microphone 31 built in the mobile terminal 30.

The command recognition unit 102 analyzes the speech acquired by the speech acquisition unit 101 and identifies a preset command. To be more specific, the command recognition unit 102 references the speech-command information previously stored in the storage unit 170, to identify the command included in the speech acquired by the speech acquisition unit 101. In the speech-command information, speech is associated with a command representing command information to be given to the TV 10. A plurality of commands are present to be given to the TV 10. Each of the commands is associated with different speech. When a command corresponding to the speech can be identified among the commands as a result of referencing the speech-command information, the command recognition unit 102 recognizes that the command is identified by the speech. Moreover, the command recognition unit 102 transmits a part other than the command included in the speech acquired by the speech acquisition unit 101, from the transmitting-receiving unit 150 to the keyword recognition unit 50 via the network 40.

The recognition result acquisition unit 103 acquires a recognition result that is obtained when the speech acquired by the speech acquisition unit 101 is recognized by the command recognition unit 102 or the keyword recognition unit 50. It should be noted that the recognition result acquisition unit 103 acquires the recognition result obtained by the keyword recognition unit 50, from the transmitting-receiving unit 150 that receives the recognition result via the network 40.

Here, the keyword recognition unit 50 acquires the part other than the command included in the speech acquired by the speech acquisition unit 101. The keyword recognition unit 50 recognizes, as a keyword, the part of the speech other than the command, and converts this part of the speech into a corresponding character string (this conversion is referred to as “dictation” hereafter).

When the recognition result acquired by the recognition result acquisition unit 103 includes a command, the command processing unit 104 causes the corresponding processing unit to perform processing according to the command. Moreover, the command processing unit 104 causes the corresponding processing unit to perform processing according to a user operation received by the operation receiving unit 110 or a user gesture operation recognized by the gesture recognition unit 111. Here, the user operation refers to an operation performed by the user and, similarly, the user gesture operation refers to a gesture made by the user. To be more specific, when the command includes a keyword or a selection command, the command processing unit 104 causes the extraction unit 105 to perform extraction processing described later. When the command includes a keyword and a search command, the command processing unit 104 causes the search unit 109 to perform search processing described later. When the command includes an operation command, the command processing unit 104 causes the selection unit 108 to perform selection processing described later. On the other hand, the recognition result acquired by the receiving result acquisition unit 103 includes only a keyword, the command processing unit 104 causes the display control unit 107 to output the keyword to the display unit 140.

In Embodiment, the keyword recognition unit 50 receives the part of the speech other than the command recognized by the command recognition unit 102, recognizes the keyword, and transmits the result of the dictation to the recognition result acquisition unit 103. However, the keyword recognition unit 50 may receive the whole speech acquired by the speech acquisition unit 101 and transmit, to the recognition result acquisition unit 103, the result of the dictation performed on the whole speech. In this case, the recognition result acquisition unit 103 divides the dictation result received from the keyword recognition unit 50 into the keyword and the command with reference to the speech-command information previously stored in the storage unit 170, and transmits the result of the division to the command processing unit 104.

When the recognition result acquired by the recognition result acquisition unit 103 includes a keyword and a selection command that is used for selecting one of the selectable information items, the extraction unit 105 performs the extraction processing to extract a selection candidate that includes the keyword from the selectable information items.

When the extraction unit 105 extracts a plurality of selection candidates, the selection mode switching unit 106 switches a selection mode from a first selection mode to a second selection mode. Here, the selection mode causes a selection to be made from among the selectable information items included in an image displayed by the display control unit 107 on the display unit 140. In the first selection mode, one of the selectable information items is allowed to be selected. In the second selection mode, one of the selection candidates is allowed to be selected.

The display control unit 107 causes the display unit 140 to display the images outputted from the selection mode switching unit 106, the selection unit 108, and the search unit 109 according to a preset display resolution. To be more specific, the display control unit 107 causes the display unit 140 to display the following images for example. When the selection unit 108 selects one of the selectable information items, the display control unit 107 causes the display unit 140 to display related information indicating a reference destination of reference information embedded in the selectable information item selected by the selection unit 108. When the selection mode is the second selection mode, the display control unit 107 causes the display unit 140 to show the selection candidates by accordingly changing the display manner. When the selection mode is the second selection mode, the display control unit 107 may further cause the display unit 140 to display a unique identifier for each of the selection candidates in an area where the selection candidate is displayed. When the selection mode is the second selection mode, the display control unit 107 causes one of the selectable information items extracted as the selection candidate to be displayed in a display manner different from a display manner in which the other selectable information items extracted as the selection candidates are displayed, according to the operation received by the operation receiving unit 110. To be more specific, the display control unit 107 causes one of the selectable information items that is selected by the user to be highlighted. Moreover, the display control unit 107 causes the display unit 140 to display results of the search performed by the search unit 109 as the selectable information items. Furthermore, the display control unit 107 causes the display unit 140 to display, as the selectable information items: results of the search by a keyword using an Internet search application; results of the search by a keyword using an electronic program guide (EPG) application; or results of the search by a keyword using search applications. In addition, the display control unit 107 may cause the display unit 140 to display, as the selectable information items, not only the results of the search by the keyword but also a plurality of hypertexts displayed as webpages.

The selection unit 108 selects one of the selectable information items according to the user operation received by the operation receiving unit 110 or the user gesture operation recognized by the gesture recognition unit 111. Moreover, when the selection mode is the second selection mode and the recognition result acquired by the recognition result acquisition unit 103 includes: a keyword indicating the identifier assigned to the selection candidate or a keyword allowing one of the selection candidates to be identified; and the selection command, the selection unit 108 selects one of the selection candidates that is identified by the keyword. Furthermore, when the operation receiving unit 110 receives an operation indicating a decision, the selection unit 108 makes a selection decision on one of the selectable information items that is displayed by the display control unit 107 on the display unit 140 in the display manner different from the display manner in which the other selectable information items are displayed.

When the recognition result acquired by the recognition result acquisition unit 103 includes a keyword and a search command associated with a preset application, the search unit 109 performs a search by this keyword using this application. Here, when the search command included in the recognition result is associated with an Internet search application that is one of the preset applications, the search unit 109 performs the search by the keyword using this Internet search application. Moreover, when the search command included in the recognition result is associated with the EPG application that is one of the preset applications, the search unit 109 performs the search by the keyword using this EPG application. Furthermore, when the search command included in the recognition result is not associated with any of the preset applications, the search unit 109 performs the search by the keyword using search applications including all the applications capable of performing the search by the keyword.

The operation receiving unit 110 receives a user operation (such as an operation to make a decision, an operation indicating a cancellation, or an operation to move a cursor). To be more specific, the operation receiving unit 110 receives the user operation by receiving an input signal via wireless communication between the TV 10 and the remote control 20 or the mobile terminal 30. Here, the input signal indicates a user operation performed on the input unit 22 of the remote control 20 or on the input unit 32 of the mobile terminal 30.

The gesture recognition unit 111 recognizes a gesture made by the user (referred to as the user gesture hereafter) by performing image processing on video shot by the internal camera 120. To be more specific, the gesture recognition unit 111 recognizes the hand of the user and then compares the hand movement made by the user with the preset commands, to identify the command that agrees with the hand movement.

### Operation

Next, an operation performed by the speech recognition apparatus 100 of the TV 10 in Embodiment is described.

### Activation of Speech Recognition Apparatus

Firstly, a method for starting speech recognition processing performed by the speech recognition apparatus 100 of the TV 10 is described. Examples of the method for starting the speech recognition processing include the following three main methods.

A first method is to press a microphone button (not illustrated) that is included in the input unit 22 of the remote control 20. More specifically, when the user presses the microphone button of the remote control 20, the operation receiving unit 110 of the TV 10 receives this operation where the microphone button of the remote control 20 is pressed. Moreover, the TV 10 sets the current volume level of sound outputted from a speaker (not illustrated) of the TV 10 to a preset volume level that is low enough to allow the speech to be easily collected by the microphone 21. Then, when the current volume level of the sound outputted from the speaker of the TV 10 is set to the preset volume level, the speech recognition apparatus 100 starts the speech recognition processing. Here, when the current volume level of the sound outputted from the speaker is low enough to allow the speech to be easily recognized, the TV 10 does not need to perform the aforementioned volume adjustment and thus does not change the current volume level. It should be noted that this method may be similarly performed by the mobile terminal 30 in place of the remote control 20. In the case where the method is performed by the mobile terminal 30 (which is a smart phone having a touch panel, for example), the speech recognition apparatus 100 starts the speech recognition processing when a microphone button displayed on the touch panel of the mobile terminal 30 is pressed in place of the pressing operation performed on the microphone button of the remote control 20. Here, the microphone button is displayed on the touch panel of the mobile terminal 30 according to an activated application that is installed in the mobile terminal 30.

A second method is to say, to the internal microphone 130 of the TV 10 as shown in FIG. 1, “Hi, TV” that is a preset start command to start the speech recognition processing. It should be noted that the words “Hi, TV” is an example of the start command and that the start command may be different words. When the speech collected by the internal microphone 130 is recognized as the present start command, the current volume level of the sound outputted from the speaker of the TV 10 is set to the preset volume level as described above. Then, the speech recognition apparatus 100 starts the speech recognition processing.

A third method is to make a preset gesture (such as a gesture to swing the hand down) to the internal camera 120 of the TV 10. When this gesture is recognized by the gesture recognition unit 111, the current volume level of the sound outputted from the speaker of the TV 10 is set to the preset volume level as described above. Then, the speech recognition apparatus 100 starts the speech recognition processing.

The method is not limited to the above methods. The speech recognition apparatus 100 may start the speech recognition processing according to a method where the first or second method is combined with the third method.

When the speech recognition apparatus 100 starts the speech recognition processing as described above, the display control unit 107 causes the display unit 140 to display a speech recognition icon 201 indicating that the speech recognition has been started and an indicator 202 indicating the volume level of collected speech, in a lower part of an image 200 as shown in FIG. 1. Although the start of the speech recognition processing is indicated by displaying the speech recognition icon 201, this is not intended to be limiting. The start of the speech recognition processing may be indicated by displaying a message saying that the speech recognition processing has been started or by outputting this message by means of sound.

### Speech Recognition

Next, the speech recognition processing performed by the speech recognition apparatus 100 of the TV 10 in Embodiment is described. The speech recognition processing performed by the speech recognition apparatus 100 in Embodiment includes two kinds of speech recognitions. One is performed to recognize a preset command (referred to as the “command recognition processing”), and the other is performed to recognize, as a keyword, speech other than the command (referred to as the “keyword recognition processing”).

The command recognition processing is performed by the command recognition unit 102 of the speech recognition apparatus 100, as described above. To be more specific, the command recognition processing is performed within the speech recognition apparatus 100. The command recognition unit 102 compares the speech uttered to the TV 10 by the user with the speech-command information previously stored in the storage unit 170, to identify the command. Here, the term “command” described here refers to a command used for operating the TV 10.

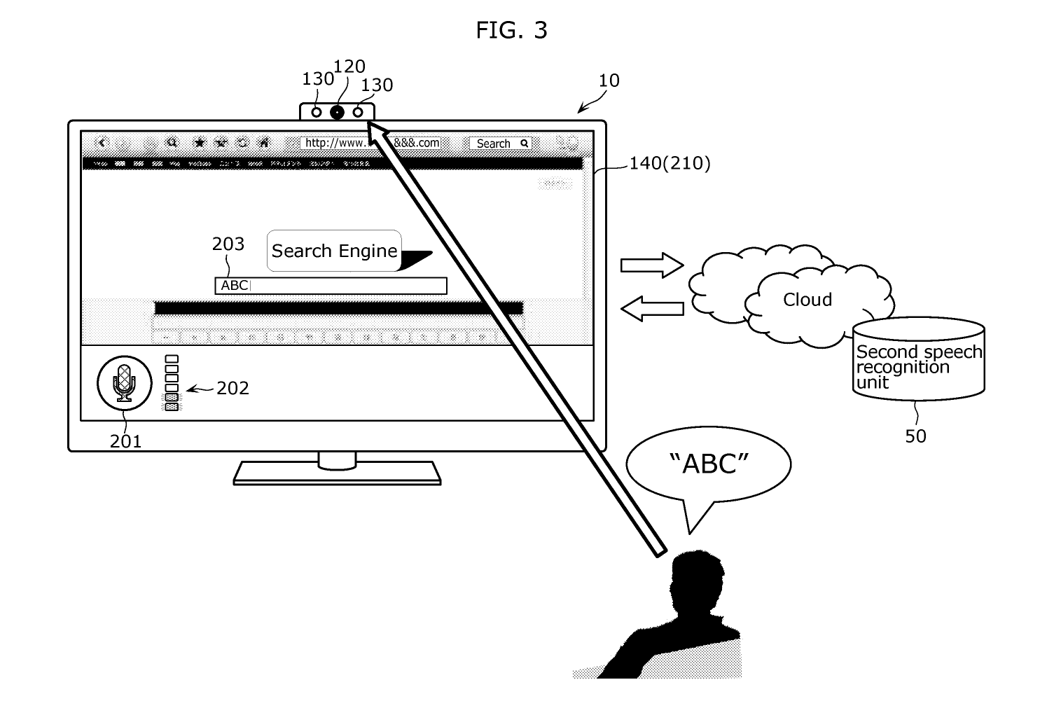

The keyword recognition processing is performed by the keyword recognition unit 50 which is the dictionary server connected to the TV 10 via the network 40, as described above (see FIG. 3). More specifically, the keyword recognition processing is performed outside the speech recognition apparatus 100. The keyword recognition unit 50 acquires the part other than the command included in the speech acquired by the speech acquisition unit 101. Then, the keyword recognition unit 50 recognizes, as the keyword, the acquired speech other than the command, and performs dictation on the acquired speech. In the dictation, the keyword recognition unit 50 uses a database where speech is associated with a character string. Thus, the keyword recognition unit 50 compares the speech with the database to convert the speech into the corresponding character string. In Embodiment, the acquired part of the speech other than the command is recognized as the keyword and then dictation is performed on this acquired part of the speech. However, note that the whole speech acquired by the speech acquisition unit 101 may be received and that dictation may be performed on this whole speech.

To be more specific, when the cursor is located in an entry field 203 for entering a search keyword in a browser and the speech recognition processing of the speech recognition apparatus 100 is started by the user, an image 210 is displayed on the display unit 140 as shown in FIG. 3. Then, when the user utters “ABC”, speech information indicating the uttered speech is transmitted to the keyword recognition unit 50 connected to the TV 10 via the network 40. The keyword recognition unit 50 compares the received speech information indicating “ABC” with the database to convert the speech into a character string “ABC”. Then, the keyword recognition unit 50 transmits character information indicating the character string obtained by the conversion, to the TV 10 via the network 40. When receiving the character information from the keyword recognition unit 50, the TV 10 enters the character string “ABC” into the entry field 203 via the recognition result acquisition unit 103, the command processing unit 104, and the display control unit 107.

In this way, by performing the speech recognition processing, the speech recognition apparatus 100 can acquire the speech uttered by the user and enter this speech as the character string into the TV 10. For example, when the acquired speech includes a command, such as “Search”, the speech recognition apparatus 100 causes the TV 10 to perform the processing according to this command. When the acquired speech includes a command and a keyword, such as “Search for ‘ABC’”, the speech recognition apparatus 100 causes the TV 10 to perform the processing using the keyword according to the command. Here, when the speech includes a command and a keyword, this means that the command is a search command associated with a preset application. In other words, a keyword search is performed using the preset application. As described above, examples of the preset application include: an Internet search application where a web browser is activated; and an EPG application where a keyword search is performed on the EPG. The search processing based on a search command is performed by the search unit 109 described above.

### Selection processing

Next, the selection processing performed by the speech recognition apparatus 100 of the TV 10 in Embodiment is described.

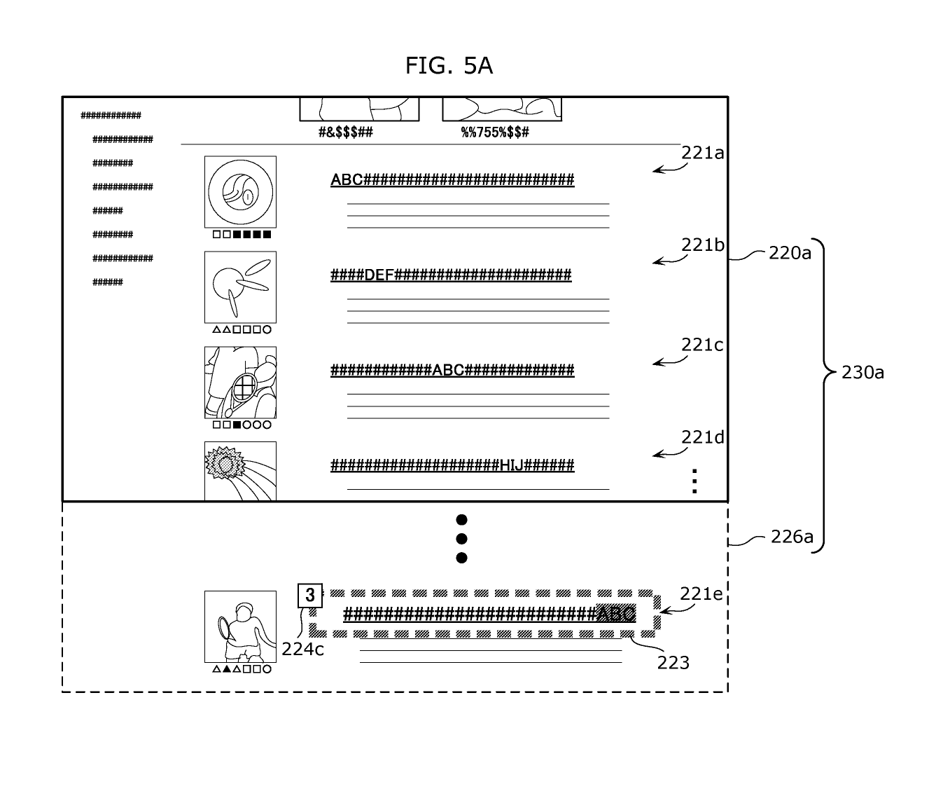

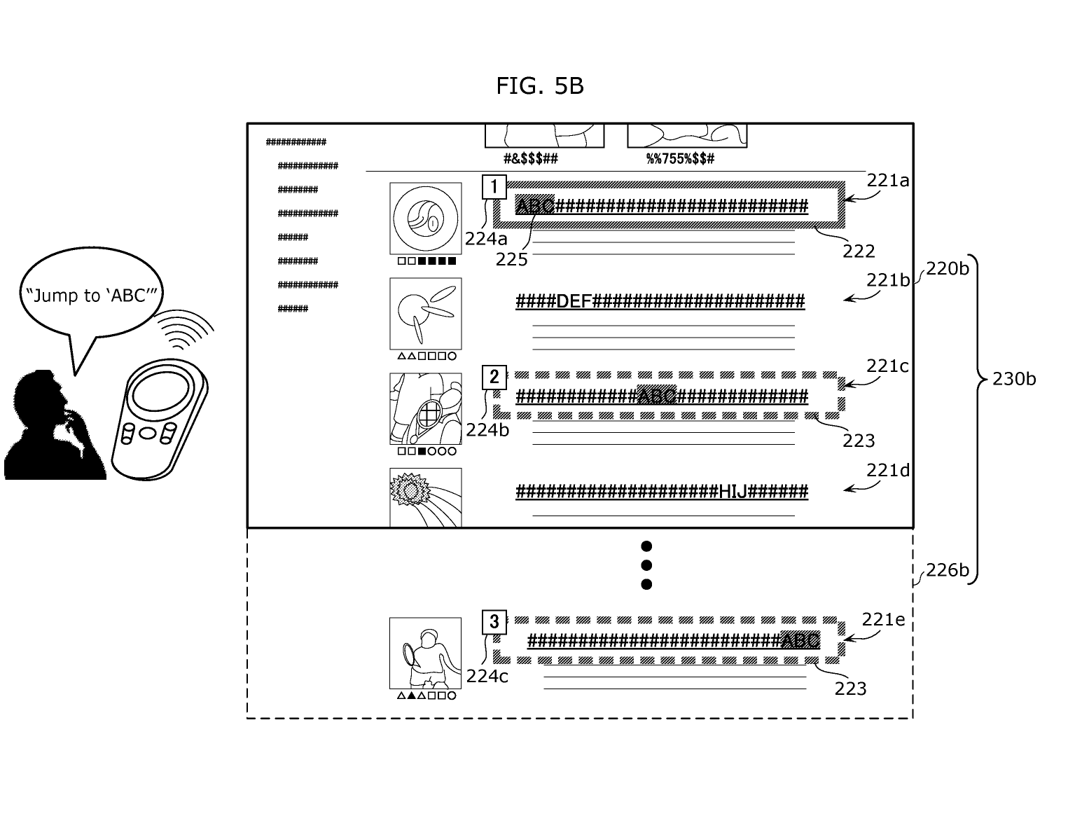

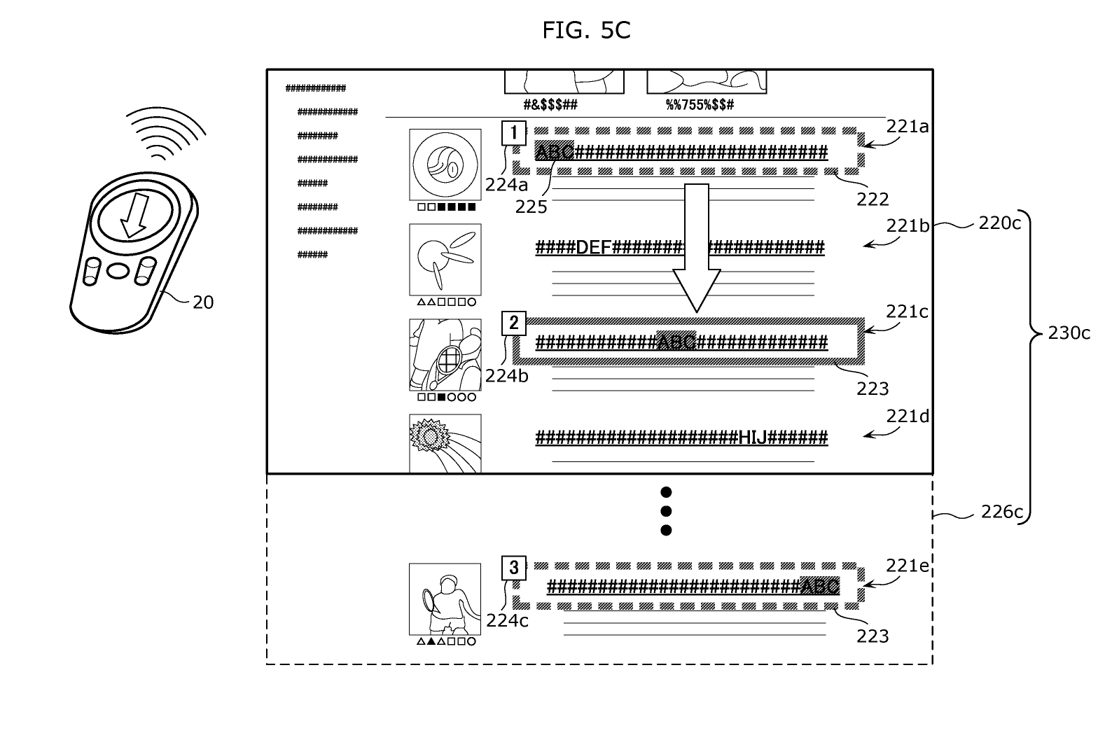

Suppose for example that a plurality of search results 221a, 221b, 221c, 221d, . . . , and 221e obtained as a result of the Internet search are being outputted by the display control unit 107 as shown in FIG. 5A. In this case, the selection processing is performed in order for an optimum search result to be selected from among the search results 221 according to speech uttered by the user. It should be noted that the search results 221a, 221b, 221c, 221d, . . . , and 221e include: the search results 221a to 221d shown in an image 220a displayed on the display unit 140; and other search results including the search result 221e in an image 226a that is not fully displayed on the display unit 140. More specifically, the search results 221a, 221b, 221c, 221d, . . . , and 221e are included in an image 230a in one page and thus can be displayed only by scrolling without any page change. Here, the image 230a includes the image 220a displayed on the display unit 140 and the image 226a that is not fully displayed on the display unit 140. Embodiment describes that the search results 221 include the search results 221a to 221d included in the image 220a displayed on the display unit 140 and the search result 221e included in the image 226a that is not fully displayed on the display unit 140. However, the search results 221 may include only the search results 221a to 221d included in the image 220a displayed on the display unit 140.

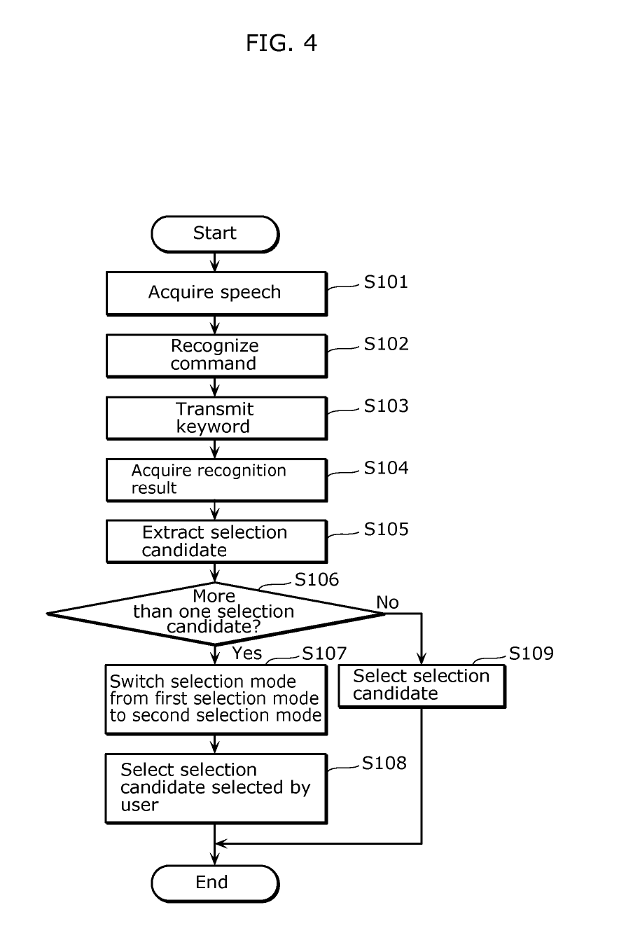

The following describes the selection processing with reference to FIG. 4 and FIG. 5A to FIG. 5C. FIG. 4 is a flowchart showing a flow of the selection processing performed by the speech recognition apparatus 100 in Embodiment. FIG. 5A is a diagram showing an image of the Internet search results. FIG. 5B is a diagram showing an example where the selection mode in the selection processing is the second selection mode. FIG. 5C is a diagram explaining the second selection mode.

The selection processing can be started when the display unit 140 displays the image 220a that is at least a part of the image 230a including the search results 221a, 221b, 221c, 221d, . . . , and 221e that are selectable information items obtained as a result of the Internet search by the keyword, as shown in FIG. 5A. Here, suppose that the user wishes to select the search result 221c through the speech recognition processing and thus focuses attention on the character string “ABC” included in the search result 221c. Then, as shown in FIG. 5B, the user starts the speech recognition processing and utters “Jump to ‘ABC’”. With this, the selection processing is started. To be more specific, the speech acquisition unit 101 acquires the speech from the user via the internal microphone 130, the microphone 21 of the remote control 20, or the microphone 31 of the mobile terminal 30 (S101).

Then, the command recognition unit 102 compares “Jump” that is a command included in the speech “Jump to ‘ABC’” acquired by the speech acquisition unit 101 with the speech-command information previously stored in the storage unit 170, and thus recognizes the command as a result of the comparison (S102). It should be noted that, in Embodiment, the command “Jump” is a selection command to select one of the selectable information items.

Out of the speech “Jump to ‘ABC’”, the command recognition unit 102 identifies, as a keyword, “ABC” other than “Jump” recognized as the command. Then, the command recognition unit 102 transmits the speech identified as the keyword to the keyword recognition unit 50 from the transmitting-receiving unit 150 via the network 40 (S103).

The keyword recognition unit 50 performs dictation on the speech information indicating the speech “ABC” to convert the speech information into the character string “ABC”. Then, the keyword recognition unit 50 transmits, as the speech recognition result, the character information indicating the character string obtained by the conversion, to the TV 10 from which the speech information indicating the speech “ABC” was originally transmitted. The recognition result acquisition unit 103 acquires the command recognized in Step S102 and the keyword that is the character string indicated by the character information transmitted from the keyword recognition unit 50 (S104).

The extraction unit 105 extracts, as a selection candidate, a selectable information item that includes the command and keyword acquired by the result acquisition unit 103 (S105). To be more specific, the extraction unit 105 extracts, as the selection candidates, the search results 221a, 221c, and 221e which are the selectable information items including a character string “ABC” 225 recognized as the keyword, from the search results 221a, 221b, 221c, 221d, . . . , and 221e shown in FIG. 5A.

The extraction unit 105 determines whether or not more than one selection candidate is extracted from the search results (S106).

When the extraction unit 105 determines that more than one selection candidate is extracted from the search results (S106: Yes), the selection mode switching unit 106 switches the selection mode that causes a selection to be made from the search results included in the image displayed on the display unit 140 by the display control unit 107, from the first selection mode to the second selection mode (S107). In the first selection mode, any one of the search results is selectable. In the second selection mode, any one of the selection candidates is selectable. To be more specific, since the extraction unit 105 extracts the three selection candidates that are the search results 221a, 221c, and 221e as shown in FIG. 5B, the selection mode is switched from the first selection mode to the second selection mode. Here, the first selection mode described here refers to, for example, a free cursor mode where the cursor can be freely moved using a mouse or the like.

When the selection mode switching unit 106 switches the selection mode to the second selection mode, an image 230b as shown in FIG. 5B is generated and an image 220b that is a part of the image 230b is displayed on the display unit 140. It should be noted that, in this case too, the image 230b includes an image 226b that is not fully displayed on the display unit 140. To be more specific, in addition to what is included in the image 230a, the image 230b includes: boxes 222 and 223 indicating that the search results 221a, 221c, and 221e are extracted as the selection candidates; and identifiers 224a, 224b, and 224c for identifying the search results 221a, 221c, and 221e, respectively. The aforementioned boxes are classified into two types as follows. The first box 222 indicates that the current selection candidate is focused to be selected from among the selection candidates. The second box 223 indicates that the current selection candidate is not focused.

When the selection mode switching unit 106 switches the selection mode to the second selection mode, one of the search results 221a, 221c, and 221e that are the selection candidates is selected according to an entry received from the user after the displayed image is changed to the image 220b in the second selection mode by the display control unit 107 (S108). It should be noted that more than one method is present for the user to select one of the selection candidates in the second selection mode.

A first method is to make a selection by selectively placing the first box 222 on the selection candidates using the input unit 22 of the remote control 20 or the input unit 32 of the mobile terminal 30, as shown in FIG.

5C. More specifically, suppose that the image 220b is currently being displayed on the display unit 140 as shown in FIG. 5B. With this state, suppose also that the user enters an operation by swiping downward on the input unit 22 of the remote control 20 as shown in FIG. 5C. As a result of this, the first box 222 indicating, before the entry from the user, that the search result 221a is focused now indicates that the search result 221c is focused as shown in an image 220c in FIG. 5C. In this way, by moving the first box 222 and entering the decision using the input unit 22 of the remote control 20 or the input unit 32 of the mobile terminal 30, the decision is made to select the search result 221c to which the first box 222 is added to indicate the focus. Here, the first box 222 can be moved only to the search result on which the second box 223 is placed. Moreover, the first box 222 may be moved not only by the entry using the input unit 22 or 32, but also by a command issued through the speech recognition processing. More specifically, the user may utter “Move downward” after starting the speech recognition processing. With this, the command recognition unit 102 may recognize the command “Move downward” and, as a result, the focused search result may be changed. Here, the operation indicating the decision may be entered using the input 22 or 32 by, for example, pressing an “Enter” button of the remote control 20 or the mobile terminal 30 or tapping the touch pad of the remote control 20. Thus, when the operation receiving unit 110 receives the operation performed on the input unit 22 or 23 to indicate the decision, the command processing unit 104 receives the command indicating the decision.

The decision made by the user is entered using the input unit 22 or 23 in Embodiment. However, the entry may be made by speech uttered to the internal microphone 130, the microphone 21, or the microphone 31. Alternatively, the entry may be made by a gesture made to the internal camera 120. In other words, regardless of whether the entry is made by speech or gesture, the command processing unit 104 determines that the entry indicating the decision is made when receiving the command indicating the decision from the user. A more specific explanation is as follows. In the case of the speech recognition processing, speech “Decision” is entered from the internal microphone 130, the microphone 21, or the microphone 31. Then, when the recognition result acquisition unit 103 acquires the recognition result that the speech includes the command “decision”, the command processing unit 104 receives the command indicating the decision. On the other hand, in the case of the gesture recognition processing, when the gesture recognition unit 111 recognizes, from the video shot by the internal camera 130, that the user made a preset gesture indicating “decision”, the command processing unit 104 receives the command indicating the decision. A second method is to press one of the buttons corresponding to numbers assigned to the identifiers 224a to 224c. For example, the user may cause the remote control 20 or the mobile terminal 30 that has a numeric keypad to display the numeric keypad, and then press the button of the number indicating the identifier. As a result, the user entry may be received as an operation command, and then a desired search result may be selected.

It is desirable for each of the numbers assigned to the identifiers to be a single-digit number, in consideration of: the convenience where the decision is made by pressing only once on the numeric keypad of the remote control 20; and the browsability by which the search results with the assigned numbers are listed on the display unit 140. Therefore, when the number of the selection candidates is 10 or more, it is desirable to assign priorities of some kind to the selection candidates to narrow down the selection candidates to the top 9 candidates in order of priority. Here, note that assigning the priorities to the search results and listing the search results in order of priority does not necessarily mean to narrow down the number of search results to 9. Thus, the search results may be simply listed in order of priority instead of narrowing down the number of search results. The order of priority may be determined according to the proportion of the keyword (the aforementioned character string “ABC” 225) used in combination with the selection command to the total number of characters in the search result.

Moreover, the identifier is not limited to a number and may be a character such as an alphabet. In this case too, when it is recognized through the speech recognition processing that the user utters the identifier assigned to the desired search result, the search result corresponding to this identifier may be selected. In the case where the speech recognition processing is employed, the identifier that is included in the speech-command information previously stored in the storage unit 170 is used to be recognized as the operation command.

Here, when receiving a command indicating “cancel” from the user after the selection mode switching unit 106 switches the selection mode to the second selection mode, the command processing unit 104 issues a cancel command to cause the selection mode switching unit 106 to switch the selection mode from the second selection mode to the first selection mode. When receiving the cancel command, the selection mode switching unit 106 switches the selection mode from the second selection mode to the first selection mode. When the selection mode is switched from the second selection mode to the first selection mode, the display control unit 107 generates the image 220a in which the first box 222, the second box 223, and the identifiers 224a to 224c are not displayed and causes the display unit 140 to display the generated image 220a.

Here, when the command processing unit 104 receives the command indicating the cancel from the user, this means that an operation indicating the cancel is performed using the input unit 22 or 23 or through the speech or gesture recognition processing, for example. In the case of the operation using the input unit 22 or 32, when the operation receiving unit 110 receives that an entry indicating the cancel (such as the press of a “Cancel” button) is made using the input unit 22 of the remote control 20 or the input unit 32 of the mobile terminal 30, the command processing unit 104 receives the command indicating the cancel. In the case of the speech recognition processing, when the speech “Cancel” is entered from the internal microphone 130, the microphone 21, or the microphone 31 and the recognition result acquisition unit 103 acquires the recognition result that the speech includes the command “cancel”, the command processing unit 104 receives the command indicating the cancel. In the case of the gesture recognition processing, when the gesture recognition unit 111 recognizes, from the video shot by the internal camera 130, that the user made a preset gesture indicating “cancel”, the command processing unit 104 receives the command indicating the cancel. As described thus far, the user can easily switch the selection mode between the first selection mode and the second selection mode.

When the extraction unit 105 determines that not more than one search result is extracted as the selection candidate (S106: No), the selection unit 108 makes a decision to select the search result that is only one selection candidate (S109).

When the decision is made to select the one selection candidate in Step S108 or Step S109, the process jumps to related information referenced by reference information embedded in the search result that is the selection candidate, and the selection processing is thus terminated. Here, the reference information refers to, for example, a uniform resource locator (URL), and the related information refers to a webpage referenced by the URL.

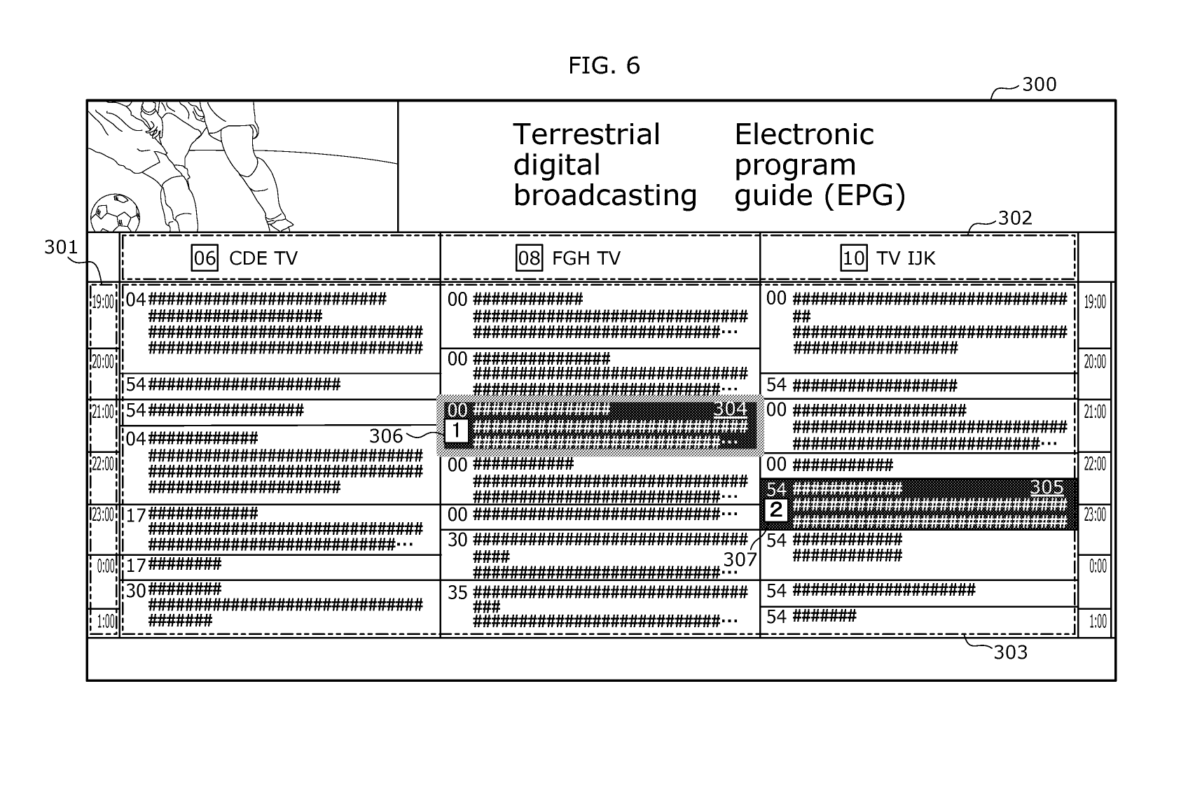

Embodiment has described the case where the speech recognition apparatus 100 performs the selection processing on the Internet search results. However, the results is not limited to the Internet search results. For example, the selection processing may be performed on the search results obtained by the EPG application. FIG. 6 shows search results obtained by the EPG. More specifically, FIG. 6 shows the search results obtained using the EPG.

An image 300 in FIG. 6 shows results of the search by a keyword according to the EPG application. As shown in FIG. 6, the image 300 includes: time information 301 indicating a broadcast time at which a current program starts; channel information 302 indicating a channel on which the program is broadcast; program information 303 indicating the program to be broadcast on the corresponding channel at the corresponding broadcast time; search results 304 and 305 indicating results of the search performed by the EPG application; and identifiers 306 and 307 identifying the search results 304 and 305, respectively.

As shown, the search results 304 and 305 extracted as the selection candidates as a result of searching the EPG by a keyword, such as a name of an actor, are displayed in a manner in which the colors of the characters and background of the program information 303 are reversed. To be more specific, the search results 304 and 305 extracted as the selection candidates are displayed in the display manner different from a display manner of the program information 303 that is not a selection candidate. In FIG. 6, the program indicated by the search result 304 is focused. Therefore, when an operation for making a decision is performed, the search result 304 is to be selected. Moreover, when an entry indicating the identifier 306 or 307 is made, the identifier 306 or 307 corresponding to this entry is to be selected, as with the Internet search results. Here, when one of the search results is selected, the details of the program information corresponding to the selected search result are displayed.

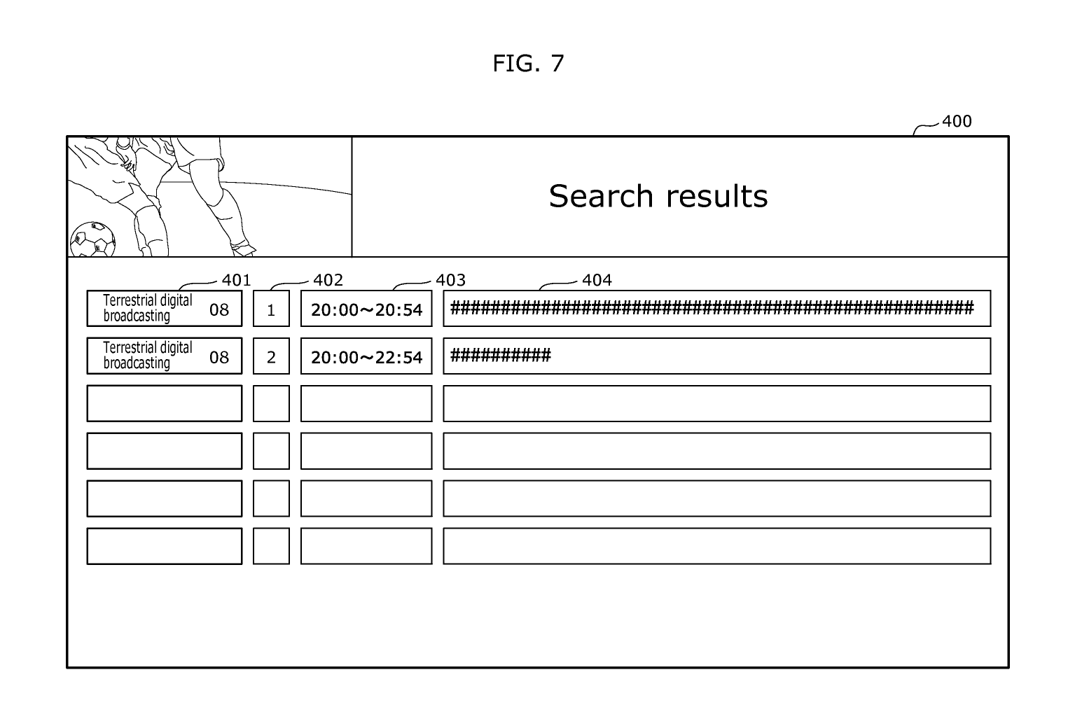

In FIG. 6, out of the search results obtained by the EPG application, the programs extracted as the selection candidates are displayed differently in the EPG. However, this is not intended to be limiting. For example, as shown in FIG. 7, the search results of the programs may be displayed in a list. An image 400 indicating the search results in a list includes channel information 401, an identifier 402, time information 403, and program information 404. In this case too, the user can select one of the selection candidates in the same way as described above.

Suppose that it is determined in the speech recognition processing that speech uttered by the user includes a search command and a keyword, and that the search command indicates a search to be performed by an Internet search application. In this case, the speech recognition apparatus 100 performs the search by the keyword using the Internet search application, although not specifically mentioned. For example, when the user utters “Search the Internet for ABC”, the speech “Search the Internet” is recognized as the search command issued for the Internet search application. Thus, simply by uttering the speech, the user can have the Internet search by the keyword performed.

Moreover, suppose that it is determined in the speech recognition processing that speech uttered by the user includes a search command and a keyword, and that the search command indicates a search to be performed by an EPG application. In this case, the search by the keyword using the EPG application is performed. For example, when the user utters “Search the EPG for ABC”, the speech “Search the EPG” is recognized as a search command issued for the EPG application. Thus, simply by uttering the speech, the user can have the EPG search by the keyword performed.

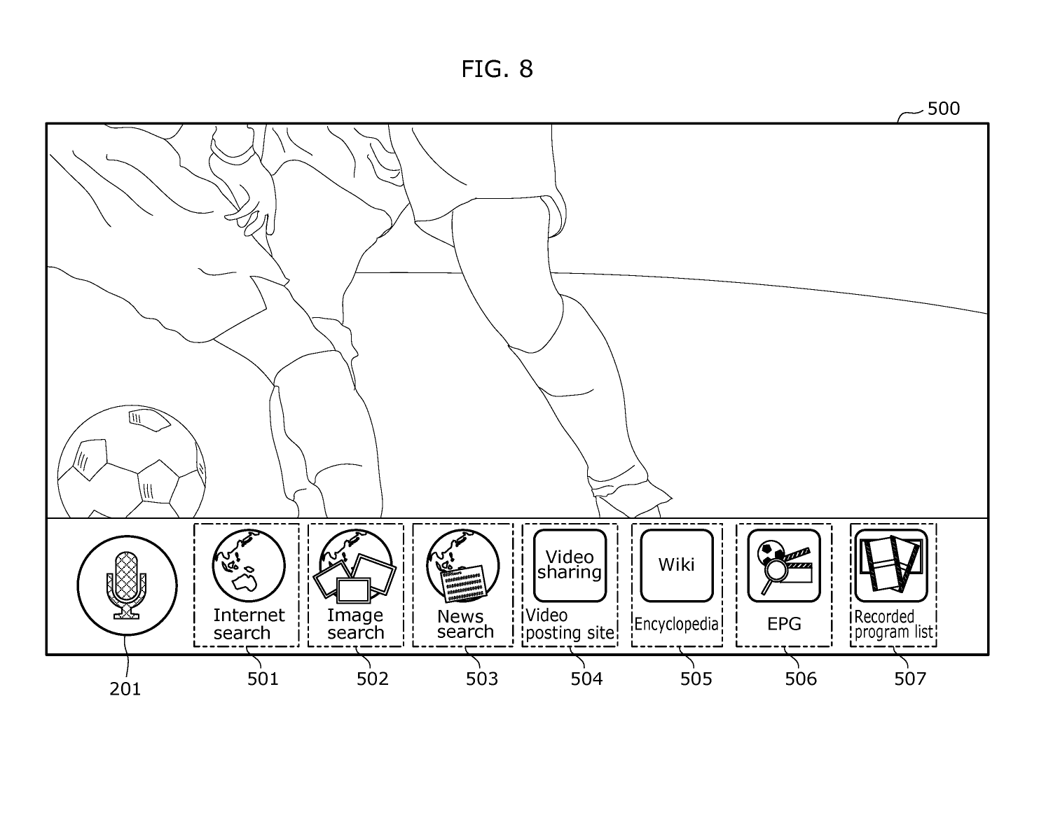

Furthermore, suppose that it is determined in the speech recognition processing that speech uttered by the user includes a search command and a keyword, and that a search command type is not specified. In this case, applications used for performing the search may be displayed on the screen in order for the user to make a selection, as shown in FIG. 8. FIG. 8 is a diagram explaining about the case where the search command type is not specified. When the search command is recognized while the search command type is not specified, icons 501 to 507 corresponding to all the applications by which the keyword search can be performed are displayed in an image 500.

In this state, when the user selects a desired application by operating the input unit 22 of the remote control 20 or the input unit 32 of the mobile terminal 30 or through the speech recognition processing, the keyword search is performed using the selected application. The icons 501 to 507 included in the image 500 represent, respectively, an Internet search application, an image search application via the Internet, a news search application via the Internet, a video posting site application, an encyclopedia application via the Internet, an EPG application, and a recorded program list application.

Moreover, suppose that it is determined in the speech recognition processing that speech uttered by the user includes a search command and a keyword, and that a search command type is not specified. In this case, the keyword search may be performed using all the applications that include the keyword, and the results obtained by these applications performing the search may be displayed.

It should be noted that since the speech recognition processing can be started according to the aforementioned method, the search as described above can be performed if only the speech recognition processing is started even when the program is being watched on the TV 10.

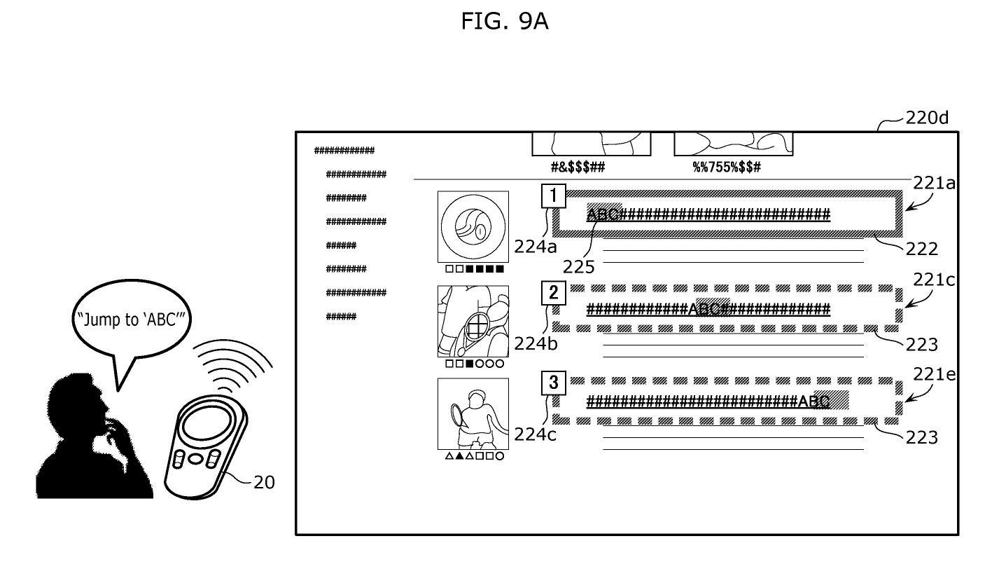

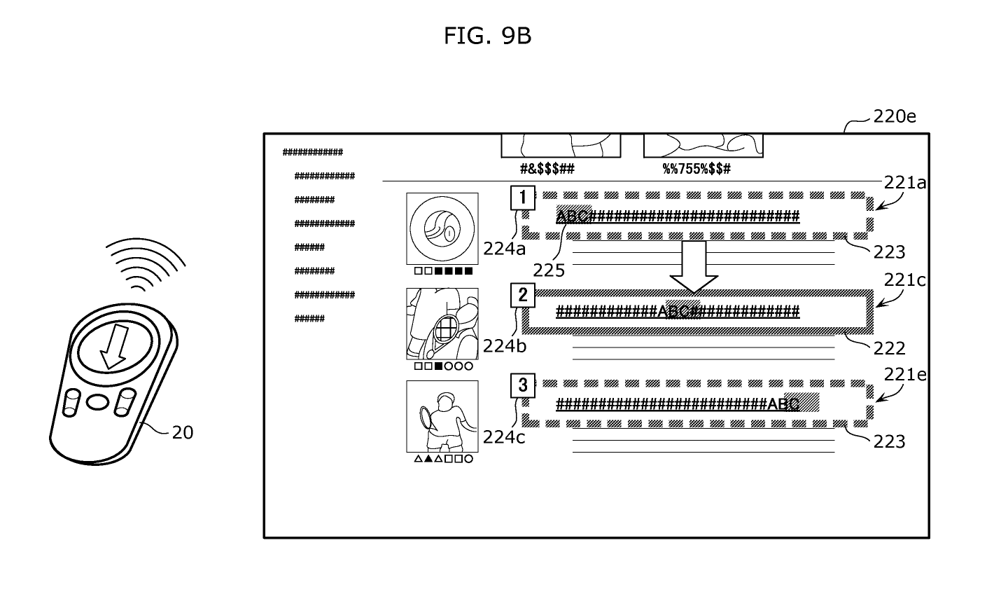

In Embodiment, when the selection mode is switched from the first selection mode to the second selection mode, the image 230b is generated by adding the first box 222, the second box 223, and the identifiers 224a, 224b, and 224c to the image 230a including all the search results 221a, 221b, 221c, 221d, . . . , and 221e as the selectable information items. However, this is not intended to be limiting. For example, when the selection mode is switched from the first selection mode to the second selection mode, an image 220d in which only the selectable information items 221a, 221c, and 221e are extracted as the selection candidates may be displayed as shown in FIG. 9A. Note that, in this case too, when the user enters an operation by swiping downward as shown in FIG. 9B, the first box 222 indicating, before the entry from the user, that the search result 221a is focused now indicates that the search result 221c is focused as shown in an image 220e in FIG. 9B.

According to the speech recognition apparatus 100 in Embodiment, the extraction unit 105 extracts the selection candidate based on the keyword and the selection command obtained as a result of the speech recognition processing. When more than one selection candidate is extracted, the first selection mode that allows one of the selectable information items to be selected is switched to the second selection mode that allows one of the extracted selection candidates to be selected. To be more specific, even when one of the selectable information items is to be selected on the basis of the keyword obtained as a result of the speech recognition processing, the selection candidates may not be narrowed down to the one since more than one selection candidate is present. In such a case, the selection mode is switched to the second selection mode in which only the selection candidates are selectable.

Therefore, the user can narrow down the selectable information items to the selectable information items that include the keyword, and thus can make the selection only from the narrowed-down selection candidates. On this account, as compared to the case where the selection is made from among all the selectable information items, the user can easily select the selectable information item that the user intends to select.

Moreover, according to the speech recognition apparatus 100 in Embodiment, the selection candidates are displayed in the display manner different from the display manner in which the other selectable information items are displayed. On this account, the user can easily discriminate the selection candidates from the selectable information items.

Furthermore, according to the speech recognition apparatus 100 in Embodiment, a unique identifier is assigned to each of the extracted selection candidates. Thus, when the selectable information item that the user intends to select is to be selected from among the selection candidates, the user can easily have the desired selectable information item selected simply by designating the identifier assigned to this desired selectable information item.

Moreover, according to the speech recognition apparatus 100 in Embodiment, the user can select the desired selectable information item only by uttering speech including: a keyword indicating the identifier assigned to the selection candidate or a keyword allowing one of the selection candidates to be identified; and the selection command that causes the selection to be made based on the keyword.

Furthermore, according to the speech recognition apparatus 100 in Embodiment, one of the selection candidates is selectively displayed in the display manner different from the display manner in which the other selection candidates are displayed, on the basis of the user operation received by the operation receiving unit 110. Then, when the user operation received by the operation receiving unit 110 indicates the decision, the selection candidate displayed in the different display manner when the present user operation is received is selected. In other words, one of the selection candidates is selectively focused according to the operation performed by the user, and this focused selection candidate is selected when the operation indicating the decision is received. Therefore, the user can easily select, from among the selection candidates, the selectable information item that the user intends to select.

Moreover, according to the speech recognition apparatus 100 in Embodiment, the selectable information items are the results of the keyword search performed by the preset application. To be more specific, even when the selectable information items are the results of the keyword search performed by the preset application, the user can easily select, from among the search results, the selectable information item that the user intends to select.

Furthermore, according to the speech recognition apparatus 100 in Embodiment, the selectable information items are the results of the keyword search performed via the Internet. To be more specific, even when the selectable information items are the results of the keyword search performed via the Internet, the user can easily select, from among the search results, the selectable information item that the user intends to select.

Moreover, according to the speech recognition apparatus 100 in Embodiment, the selectable information items are the results of the keyword search performed by the EPG application. To be more specific, even when the selectable information items are the results of the keyword search performed by the EPG application, the user can easily select, from among the search results, the selectable information item that the user intends to select.

Furthermore, according to the speech recognition apparatus 100 in Embodiment, the selectable information items are the results of the keyword search performed by all the search applications. To be more specific, even when the selectable information items are the results of the keyword search performed by all the search applications, the user can easily select, from among the search results, the selectable information item that the user intends to select.

Moreover, according to the speech recognition apparatus 100 in Embodiment, the selectable information items are the hypertexts. To be more specific, even when the selectable information items are the hypertexts, the user can easily select, from among the hypertexts, the selectable information item that the user intends to select.

The herein disclosed subject matter is to be considered descriptive and illustrative only, and the appended Claims are of a scope intended to cover and encompass not only the particular embodiment disclosed, but also equivalent structures, method, and/or uses. Moreover, the following are also intended to be included in the present disclosure.

(1) Each of the above-described apparatuses may be, specifically speaking, implemented as a system configured with a microprocessor, a ROM, a RAM, a hard disk unit, a display unit, and so forth. The RAM or the hard disk unit stores a computer program. The microprocessor operates according to the computer program and, as a result, each function of the apparatus is carried out. Here, note that the computer program includes a plurality of instruction codes indicating instructions to be given to the microprocessor to achieve a specific function.

(2) Some or all of the structural elements included in each of the above-described apparatuses may be realized as a single system Large Scale Integration (LSI). The system LSI is a super multifunctional LSI manufactured by integrating a plurality of structural elements onto a signal chip. To be more specific, the system LSI is a computer system configured with a microprocessor, a ROM, a RAM, and so forth. The RAM stores a computer program. The microprocessor loads the computer program from the ROM into the RAM and, as a result, the system LSI carries out the function.

(3) Some or all of the structural elements included in each of the above-described apparatuses may be implemented as an IC card or a standalone module that can be inserted into and removed from the corresponding apparatus. The IC card or the module is a computer system configured with a microprocessor, a ROM, a RAM, and so forth. The IC card or the module may include the aforementioned super multifunctional LSI. The microprocessor operates according to the computer program and, as a result, a function of the IC card or the module is carried out. The IC card or the module may be tamper resistant.

(4) The present disclosure may be the methods described above. Each of the methods may be a computer program causing a computer to execute the steps included in the method. Moreover, the present disclosure may be a digital signal of the computer program.

Moreover, the present disclosure may be implemented as the aforementioned computer program or digital signal recorded on a computer-readable recording medium, such as a flexible disk, a hard disk, a CD-ROM, an MO, a DVD, a DVD-ROM, a DVD-RAM, a Blu-ray Disc (BD) (registered trademark), or a semiconductor memory. Also, the present disclosure may be implemented as the digital signal recorded on such a recording medium.

Furthermore, the present disclosure may be implemented as the aforementioned computer program or digital signal transmitted via a telecommunication line, a wireless or wired communication line, a network represented by the Internet, and data broadcasting.

Moreover, the present disclosure may be implemented as a computer system including a microprocessor and a memory. The memory may store the aforementioned computer program and the microprocessor may operate according to the computer program.

Moreover, by transferring the recording medium having the aforementioned program or digital signal recorded thereon or by transferring the aforementioned program or digital signal via the aforementioned network or the like, the present disclosure may be implemented as a different independent computer system.

(5) Embodiment described above and modifications may be combined.

In the above description, the embodiment has been explained as an example of technology in the present disclosure. For the explanation, the accompanying drawings and detailed description are provided.

On account of this, the structural elements explained in the accompanying drawings and detailed description may include not only the structural elements essential to solve the problem, but also the structural elements that are not essential to solve the problem and are described only to show the above implementation as an example. Thus, even when these nonessential structural elements are described in the accompanying drawings and detailed description, this does not mean that these nonessential structural elements should be readily understood as essential structural elements.

Moreover, the embodiment described above is merely an example for explaining the technology in the present disclosure. On this account, various changes, substitutions, additions, and omissions are possible within the scope of Claims or an equivalent scope.

Although only an exemplary embodiment in the present disclosure has been described in detail above, those skilled in the art will readily appreciate that many modifications are possible in the exemplary embodiment without materially departing from the novel teachings and advantages in the present disclosure. Accordingly, all such modifications are intended to be included within the scope of the present disclosure.

The present disclosure is applicable to a speech recognition apparatus capable of easily selecting, through speech recognition, a selectable information item that a user intends to select. To be more specific, the present disclosure is applicable to a television set and the like.

1. An image display apparatus, comprising:
a display unit configured to display an image; and
a processor which assists a user to select one of selectable information items when the display unit displays the selectable information items in each of which reference information for referencing related information is embedded,
wherein the processor includes:
a speech acquisition unit configured to acquire speech uttered by the user;
a recognition result acquisition unit configured to acquire a result of recognition performed on the speech acquired by the speech acquisition unit;
an extraction unit configured, when the recognition result includes a keyword and a selection command that is used for selecting one of the selectable information items, to extract at least one selection candidate that includes the keyword, from the selectable information items;
a selection mode switching unit configured to switch a selection mode from a first selection mode to a second selection mode when the at least one selection candidate extracted by the extraction unit comprises a plurality of selection candidates, the selection mode causing one of the selectable information items to be selected, the first selection mode allowing a selection to be made from among the selectable information items, and the second selection mode allowing the selection to be made from among the selection candidates; and
a display control unit configured to change a display manner in which the display information is displayed, according to the second selection mode switched from the first selection mode by the selection mode switching unit, and
when the selection mode is the second selection mode, the display control unit is configured to display a unique identifier for each of the selection candidates to identify the selection candidate.

2. An image display apparatus, comprising:
a display unit configured to display an image; and
a processor which assists a user to select one of selectable information items when the display unit displays the selectable information items in each of which reference information for referencing related information is embedded,
wherein the processor includes:
a speech acquisition unit configured to acquire speech uttered by the user;
a recognition result acquisition unit configured to acquire a result of recognition performed on the speech acquired by the speech acquisition unit;
an extraction unit configured, when the recognition result includes a keyword and a selection command that is used for selecting one of the selectable information items, to extract at least one selection candidate that includes the keyword, from the selectable information items;
a selection mode switching unit configured to switch a selection mode from a first selection mode to a second selection mode when the at least one selection candidate extracted by the extraction unit comprises a plurality of selection candidates, the selection mode causing one of the selectable information items to be selected, the first selection mode allowing a selection to be made from among the selectable information items, and the second selection mode allowing the selection to be made from among the selection candidates;
a display control unit configured to change a display manner in which the display information is displayed, according to the second selection mode switched from the first selection mode by the selection mode switching unit; and
a search unit configured, when the recognition result acquired by the recognition result acquisition unit includes a keyword and a search command that is associated with a preset application, to perform a search by the keyword using the preset application, and
the display control unit is configured to display, as the selectable information items, results of the search performed by the search unit.

3. An image display apparatus, comprising:
a display unit configured to display an image; and
a processor which assists a user to select one of selectable information items when the display unit displays the selectable information items in each of which reference information for referencing related information is embedded,
wherein the processor includes:
a speech acquisition unit configured to acquire speech uttered by the user;
a recognition result acquisition unit configured to acquire a result of recognition performed on the speech acquired by the speech acquisition unit;
an extraction unit configured, when the recognition result includes a keyword and a selection command that is used for selecting one of the selectable information items, to extract at least one selection candidate that includes the keyword, from the selectable information items;
a selection mode switching unit configured to switch a selection mode from a first selection mode to a second selection mode only when the at least one selection candidate extracted by the extraction unit comprises a plurality of selection candidates, the selection mode causing one of the selectable information items to be selected, the first selection mode allowing a selection to be made from among the selectable information items, and the second selection mode allowing the selection to be made from among the selection candidates;
a display control unit configured to change a display manner in which the display information is displayed, according to the second selection mode switched from the first selection mode by the selection mode switching unit.

4. The image display apparatus according to claim 3,
wherein when the at least one selection candidate extracted by the extraction unit is one selection candidate, the display control unit is configured to display the related information which is referenced by the one selection candidate.

5. The image display apparatus according to claim 3, further comprising
an operation receiving unit configured to receive an operation from the user,
wherein the operation receiving unit is configured to receive (i) a free cursor operation in the first selection mode, and (ii) a predetermined command operation or a swipe operation performed in a predetermined direction, in the second selection mode.

6. An image display method for an image display apparatus, the image display apparatus including a display unit configured to display an image and a processor which assists a user to select one of selectable information items when the display unit displays the selectable information items in each of which reference information for referencing related information is embedded, the image display method comprising:
a speech acquisition step of acquiring speech uttered by the user;
a recognition result acquisition step of acquiring a result of recognition performed on the speech acquired by the speech acquisition step;
an extraction step of, when the recognition result includes a keyword and a selection command that is used for selecting one of the selectable information items, extracting at least one selection candidate that includes the keyword, from the selectable information items;
a selection mode switching step of switching a selection mode from a first selection mode to a second selection mode when the at least one selection candidate extracted by the extraction step comprises a plurality of selection candidates, the selection mode causing one of the selectable information items to be selected, the first selection mode allowing a selection to be made from among the selectable information items, and the second selection mode allowing the selection to be made from among the selection candidates; and
a display control step of changing a display manner in which the display information is displayed, according to the second selection mode switched from the first selection mode by the selection mode switching step, and
when the selection mode is the second selection mode, the display control step displays a unique identifier for each of the selection candidates to identify the selection candidate.

7. An image display method for an image display apparatus, the image display apparatus including a display unit configured to display an image and a processor which assists a user to select one of selectable information items when the display unit displays the selectable information items in each of which reference information for referencing related information is embedded, the image display method comprising:
a speech acquisition step of acquiring speech uttered by the user;
a recognition result acquisition step of acquiring a result of recognition performed on the speech acquired by the speech acquisition step;
an extraction step of, when the recognition result includes a keyword and a selection command that is used for selecting one of the selectable information items, extracting at least one selection candidate that includes the keyword, from the selectable information items;
a selection mode switching step of switching a selection mode from a first selection mode to a second selection mode when the at least one selection candidate extracted by the extraction step comprises a plurality of selection candidates, the selection mode causing one of the selectable information items to be selected, the first selection mode allowing a selection to be made from among the selectable information items, and the second selection mode allowing the selection to be made from among the selection candidates;
a display control step of changing a display manner in which the display information is displayed, according to the second selection mode switched from the first selection mode by the selection mode switching step; and
a search step of, when the recognition result acquired by the recognition result acquisition step includes a keyword and a search command that is associated with a preset application, performing a search by the keyword using the preset application, and
the display control step displays, as the selectable information items, results of the search performed by the search step.

8. A selection assisting method for an image display apparatus, the image display apparatus including a display unit configured to display an image and a processor which assists a user to select one of selectable information items when the display unit displays the selectable information items in each of which reference information for referencing related information is embedded, the selection assisting method comprising:
a speech acquisition step of acquiring speech uttered by the user;
a recognition result acquisition step of acquiring a result of recognition performed on the speech acquired by the speech acquisition step;
an extraction step of, when the recognition result includes a keyword and a selection command that is used for selecting one of the selectable information items, extracting at least one selection candidate that includes the keyword, from the selectable information items;
a selection mode switching step of switching a selection mode from a first selection mode to a second selection mode only when the at least one selection candidate extracted by the extraction step comprises a plurality of selection candidates, the selection mode causing one of the selectable information items to be selected, the first selection mode allowing a selection to be made from among the selectable information items, and the second selection mode allowing the selection to be made from among the selection candidates;
a display control step of changing a display manner in which the display information is displayed, according to the second selection mode switched from the first selection mode by the selection mode switching step.
